(19) United States
(12) Patent Application Publication
(10) Pub. No.: US 2020/0213856 A1
(43) Pub. Date: Jul. 2, 2020

(54) METHOD AND A DEVICE FOR SECURITY MONITORING OF A WIFI NETWORK

(71) Applicant: SHANGHAI ZHANGMEN SCIENCE AND TECHNOLOGY CO., LTD., SHANGHAI (CN)

(72) Inventor: Han CHENG, SHANGHAI (CN)

(21) Appl. No.: 16/809,584

(22) Filed: Mar. 5, 2020

Related U.S. Application Data
(63) Continuation of application No. PCT/CN2018/100623, filed on Aug. 15, 2018.

(30) Foreign Application Priority Data
Sep. 7, 2017 (CN) 201710802886.5

(51) Int. Cl. H04W 12/12; H04W 24/08; H04L 29/06; H04W 12/00; H04W 84/18

(52) U.S. Cl. CPC H04W 12/12; H04W 24/08; H04L 63/1408; H04W 12/00505; H04W 84/18; H04L 63/20

(57) ABSTRACT

The present application provides a method and a device for security monitoring on a WiFi network. The method comprises: acquiring first network security monitoring information corresponding to a target WiFi network that is transmitted by a user equipment, wherein the first network security monitoring information is acquired when the user equipment is connected to the target WiFi network; determining network security state information of the target WiFi network based on the first network security monitoring information; providing the network security state information to an administrative user of the target WiFi network. Here, the present application is a breakthrough to a conventional operation of network security detection by means of security scanning of an intelligent router in the prior art. Even if the target WiFi is connected via only a normal router, real-time security monitoring of the network may be implemented by the technical solution of the present application.

### CROSS REFERENCE TO THE RELATED APPLICATION

This application is the continuation application of International Application No. PCT/CN2018/100623, filed on Aug. 15, 2018, which is based upon and claims priority to Chinese Patent Application No. 201710802886.5, filed on Sep. 7, 2017, the entire contents of which are incorporated herein by reference.

### FIELD

The present application relates to communication, and more particularly relates to a technology for security monitoring of a WiFi network.

### BACKGROUND

With the development of Internet technology, it has become a daily habit of Internet users to access the Internet through a WiFi (wireless fidelity) network connection anytime and anywhere. Accompanying WiFi network security issues always pose a great threat to the information security of Internet users. The existing security solution of WiFi networks is usually implemented by an intelligent router corresponding to the WiFi network through security scanning to implement network security detection and corresponding security management. However, the security scan of the intelligent router does not accurately reflect the real-time security status of Internet users when using the WiFi network. The probability of a security detection breach is high. In addition, when the WiFi network corresponds to a non-intelligent router, it is impossible to detect security issues through the router's own security scan.

### SUMMARY

An objective of the present application is to provide a method and a device for security monitoring of a WiFi network.

According to an aspect of the present application, it is provided a method for security monitoring of a WiFi network at a network device. The method comprises:

acquiring first network security monitoring information corresponding to a target WiFi network that is transmitted by a user equipment, wherein the first network security monitoring information is acquired when the user equipment is connected to the target WiFi network;

determining network security state information of the target WiFi network based on the first network security monitoring information;

providing the network security state information to an administrative user of the target WiFi network.

According to another aspect of the present application, it is provided a method for security monitoring of a WiFi network at a user equipment. The method comprises:

connecting to a target WiFi network;

scanning first network security monitoring information of the target WiFi network when the user equipment is connected to the target WiFi network;

transmitting the first network security monitoring information to a corresponding network device.

According to another aspect of the present application, it is also provided a system for security monitoring of a WiFi network. The system comprises a network device as mentioned above which performs a method for security monitoring of a WiFi network and a user equipment as mentioned above which performs a method for security monitoring of a WiFi network.

According to yet another aspect of the present application, it is provided a method for security monitoring of a WiFi network at a network device. The method comprises:

acquiring first network security monitoring information corresponding to a target WiFi network that is transmitted by a user equipment, wherein the first network security monitoring information is acquired when the user equipment is connected to the target WiFi network;

determining network security state information of the target WiFi network based on the first network security monitoring information.

According to another aspect of the present application, it is also provided a device for security monitoring of a WiFi network. The device comprises:

one or more processors;

a memory; and

one or more programs stored in the memory and configured to be executed by the one or more processors, wherein the one or more programs, when executed, cause the above mentioned methods to be performed.

According to another aspect of the present application, it is also provided a computer readable storage medium storing computer programs thereon, the computer programs being executable by a processor, and wherein the computer programs, when executed, cause the above mentioned methods to be performed.

Compared with the prior art, in the present application, a network device acquires first network security monitoring information corresponding to a target WiFi network acquired when a user equipment is connected to the target WiFi network, and provides network security state information of the target WiFi network determined based on the first network security monitoring information to an administrative user of the target WiFi network. In the present application, the network security state information of the target WiFi network may be determined based on the first network security monitoring information acquired by devices using the target WiFi network, such as the user equipment, via scanning. The network device provides the determined network security state information to the administrative user of the target WiFi network to implement security management of the target WiFi network. Here, the present application is a breakthrough to a conventional operation of network security detection by means of security scanning of an intelligent router in the prior art. Even if the target WiFi is connected via only a normal router, real-time security monitoring of the network may be implemented based on the technical solution of the present application. Meanwhile, based on the technical solution of the present application, real time security conditions of Internet users when using WiFi networks may be accurately reflected. Compared with the security scanning by an intelligent router, the technical solution of the present application may better meet the timeliness requirements of network security protection, and make up for possible loopholes in the security detection of the intelligent router.

### DESCRIPTIONS OF THE DRAWINGS

Other features, objects, and advantages of the present application will become more apparent by reading the detailed description of non-limiting embodiments with reference to the following drawings:

FIG. 1 shows a flowchart of a method for security monitoring of a WiFi network at a network device and a user equipment according to an aspect of the present application;

FIG. 2 shows a flowchart of a method for security monitoring of a WiFi network at a network device according to another aspect of the present application.

The identical or similar reference numerals in the drawings represent the identical or similar components.

### DETAILED EMBODIMENTS

The application is further described in detail below with reference to the accompanying drawings.

In a typical configuration of the present application, a terminal, a device of a service network and a trusted party all include one or more processors (CPUs), an input/output interface, a network interface and a memory.

The memory may include a non-permanent memory, a random access memory (RAM) and/or a non-volatile memory and the like in a computer-readable medium, such as a read-only memory (ROM) or a flash memory (flash RAM)). A memory is an example of a computer-readable medium.

A computer-readable medium comprises permanent and non-permanent, movable and non-movable media and may implement information storage by means of any method or technology. Information may be computer-readable instructions, data structures, program modules or other data. The examples of a computer storage medium include but are not limited to a phase change memory (PRAM), a static random access memory (SRAM), a dynamic random access memory (DRAM), other types of random access memory (RAM), a read-only memory (ROM), an electrically erasable programmable read-only memory (EEPROM), a flash memory or other memory technologies, compact disk read-only memory (CD-ROM), a digital versatile disc (DVD) or other optical storages, a magnetic cassette tape, and magnetic tape and magnetic disk storage or other magnetic storage devices or any other non-transmission media, which may be used to store information that may be accessed by a computing device. According to the definition herein, the computer-readable medium does not include a non-transitory computer-readable medium, such as a modulated data signal and a carrier.

The embodiments of the present application provide a method for security monitoring of a WiFi network. The method may be implemented at a corresponding network device, or implemented at a corresponding user equipment, or implemented via cooperation of the network device and the user equipment.

The network device may include but is not limited to computers, network hosts, a single network server, multiple network server sets or cloud servers. Cloud server may be a virtual supercomputer operating on a distributed system, which is composed of a group of loosely coupled computer sets, and implements simple, efficient, safe and reliable computing services with scalable computing capabilities. The user equipment includes but is not limited to various types of personal computers, mobile intelligent devices, a network host, a single network server, multiple network server sets or cloud servers. The user equipment may include but is not limited to various types of personal computers, mobile intelligent devices and the like that are capable of wireless Internet access. In an implementation, the network device may provide a shared use of a WiFi network to massive amounts of users. The network device may store a large amount of information related to the WiFi network, for example access information of the WiFi network such as access password, or wireless router information corresponding to the WiFi network, etc.

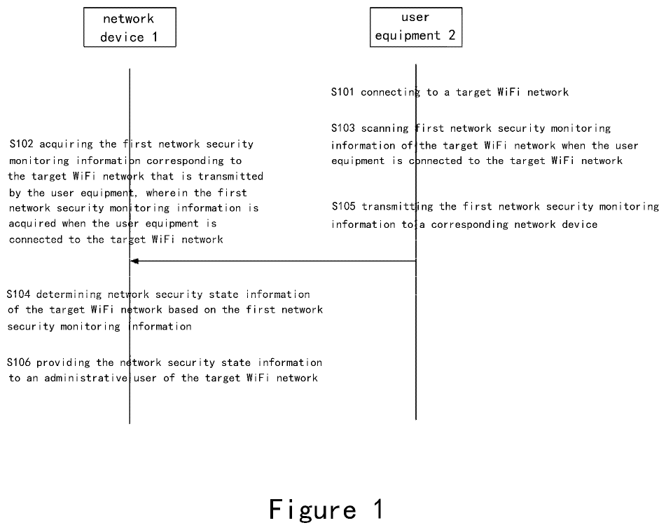

FIG. 1 shows a flowchart of a method for security monitoring of a WiFi network at a network device and a user equipment according to an aspect of the present application. The method comprises step S101, step S103, step S105, step S102, step S104 and step S106.

At step S101, user equipment 2 connects to a target WiFi network. At step S103, the user equipment 2 scans first network security monitoring information of the target WiFi network when the user equipment 2 is connected to the target WiFi network. At step S105, the user equipment 2 transmits the first network security monitoring information to a corresponding network device 1. Here, the network device 1 may store wireless router information corresponding to the target WiFi network and/or access information of the target WiFi network submitted by an administrative user of the target WiFi network. Correspondingly, at step S102, the network device 1 acquires the first network security monitoring information corresponding to the target WiFi network that is transmitted by the user equipment 2, wherein the first network security monitoring information is acquired when the user equipment 2 is connected to the target WiFi network. At step S104, the network device 1 determines network security state information of the target WiFi network based on the first network security monitoring information. At step S106, the network device 1 provides the network security state information to an administrative user of the target WiFi network.

Specifically, in practical applications, if the target WiFi network has a security issue, for example a security issue caused by poor protection of a wireless router corresponding to the target WiFi network, the most direct result is that the user equipment 2 using the target WiFi network might confront with corresponding network security dangers when connected to the target WiFi network. In an example, the user equipment 2 may be vulnerable to webpage attacks, webpage malicious code, etc. due to low security level of the WiFi network, thereby causing personal information leakage in the user equipment 2. Therefore, in the present application, the user equipment 2 uses the first network security monitoring information scanned when using the WiFi network as a criterion for determining whether the target WiFi network has security issues or security risks and determines optimization proposals for the security management of the wireless router. In an example, the administrative user may be prompted to modify the encryption mode of the wireless router of the target WiFi network to a more complicated encryption mode. In another example, the administrative user may be prompted to update the firmware of the wireless router. In a further example, the administrative user may be prompted to turn on or update the firewall functions of the wireless router. In yet another example, the administrative user may be prompted to turn on MAC address filtering functions, or to bond MAC addresses of devices authorized to access, etc.

At step S101, the user equipment 2 connects to the target WiFi network. In an implementation, the network device 1 corresponding to the user equipment 2 may provide a shared use of the WiFi network to massive amounts of users. The network device 1 may store a large amount of information about the WiFi network, for example access information of the WiFi network such as a connection password, or wireless router information corresponding to the WiFi network, etc. On such basis, in one implementation, the user equipment 2 may establish a wireless connection to the target WiFi network based on the access information corresponding to the target WiFi network acquired from the network device 1. In addition, the user equipment 2 may also acquire the access information of the target WiFi network based on other methods.

At step S103, the user equipment 2 scans the first network security monitoring information of the target WiFi network when the user equipment 2 is connected to the target WiFi network. In an implementation, the first network security monitoring information is the information related to network security that may be detected when the user equipment 2 uses the target WiFi network. In an embodiment, the first network security monitoring information may include one or more specific pieces of network security metrics information. The network security metrics information includes any parameter metrics that are related to network security and reflect current network state of the target WiFi network, for example, specific information detected and determined by the user equipment by performing various of network security detection methods.

In an example, the network security metrics information may be encryption mode information of the target WiFi network, for example, OPEN, WEP, WPA-PSK (TKIP), WPA2-PSK (AES) or WPA-PSK (TKIP)+WPA2-PSK (AES), etc. In an implementation, the user equipment 2 may acquire corresponding encryption mode information when scanning the target WiFi network.

In another example, the network security metrics information may be detection information indicating whether the target WiFi is a phishing WiFi, for example, possible detection information indicating the target WiFi is not phishing WiFi, or the target WiFi is a phishing WiFi, or the target WiFi is suspected to be a phishing WiFi. In an implementation, after the user equipment 2 connects to the target WiFi network, the user equipment 2 may transmit network verification packet to a wireless router corresponding to the target WiFi network, and determines whether the target WiFi is a phishing WiFi based on the data fed by the wireless router based on the network verification packet.

In yet another example, the network security metrics information may be detection information indicating whether the target WiFi is being monitored, for example, possible detection information indicating that the target WiFi is being monitored, or the target WiFi is not being monitored, or the target WiFi is suspected to be monitored. In an implementation, a pint test may be performed on a device which is suspected to be installed with a monitoring program based on correct IP addresses and wrong physical addresses. If there is a monitoring device, it will respond to the ping test, which may be used to determine whether the target WiFi network is being monitored.

In a further example, the network security metrics information may be detection information indicating whether the current webpage will automatically jump to a phishing website, for example, possible detection information indicating that the current webpage will automatically jump to a phishing website, or the current webpage will not automatically jump to a phishing website, or the current webpage will automatically jump to a website suspected to be phishing website. In an implementation, if the webpage automatically jumps to a phishing website when the user is browsing the webpage, possible reasons may include the router DNS being kidnapped, or webpage script being injected. Here, targeted detection may be performed for possible different reasons.

In yet another example, the network security metrics information may be detection information indicating whether there is webpage malicious code, for example, possible detection information indicating that there is webpage malicious code, there is no webpage malicious code, or webpage malicious code is suspected to exist. In an implementation, it may be determined whether the webpage is a malicious code webpage by matching features in the webpage to be detected one by one against a preset malicious code feature database.

Here, it should be understood by those skilled in the art that the above-mentioned network security metrics information is merely an example. Other existing network security metrics information or network security metrics information that might appear in the future, if applicable to the present application, should also be included in the protection scope of the present application and incorporated herein by reference.

Here, it should be understood by those skilled in the art that the above-mentioned ways of acquiring the network security metrics information are merely examples. Other existing ways of acquiring network security metrics information or ways of acquiring network security metrics information that might appear in the future, if applicable to the present application, should also be included in the protection scope of the present application and incorporated herein by reference.

In an implementation, the user equipment 2 may set a scanning period for the first network security monitoring information to acquire the most updated data of various network security metrics information regularly.

In an implementation, the first network security monitoring information may also include preliminary determination information on network security corresponding to the target WiFi network. The network device 1 subsequently may determines the network security state information of the target WiFi network based on the network security metrics information in the network security monitoring information submitted by the user equipment 2 in connection with the corresponding preliminary determination information on network security. In an implementation, the user equipment 2 may determine the network security of the target WiFi network as one of different security levels preliminarily, such as secure, insecure, suspected to be insecure, based on the various network security metrics information in connection with a certain determination rule. An example of the determination rule may be that when at least one piece of network security metrics information labeled as important has security risk, the preliminary determination information on network security is determined as insecure. In an example, detection information indicating whether the target WiFi is a phishing WiFi is set as important network security metrics information. If it is detected that the target WiFi is a phishing WiFi, the preliminary determination information on network security corresponding to the target WiFi network may be determined as insecure. At the same time, a result of being insecure as well as the network security metrics information are uploaded to the network device 1.

At step S105, the user equipment 2 then transmits the first network security monitoring information of the target WiFi network to the corresponding network device 1. Here, the network device 1 stores wireless router information corresponding to the target WiFi network and/or access information of the target WiFi network submitted by an administrative user of the target WiFi network. In an implementation, the network security monitoring information submitted by the user equipment 2 is matched with a corresponding timestamp. The timestamp may be the time when the network security monitoring information received by the network device is acquired. Here, the timestamp may correspond to the time information when the network security monitoring information is determined and generated, or the timestamp may correspond to the time information when the network security monitoring information is uploaded.

Correspondingly, at step S102, the network device 1 acquires first network security monitoring information corresponding to the target WiFi network that is transmitted by the user equipment 2, wherein the first network security monitoring information is acquired when the user equipment 2 is connected to the target WiFi network. In an implementation of the present application, the network device 1 may acquire second network security monitoring information corresponding to the target WiFi network uploaded by one or more other user equipments similar to the user equipment 2.

At step S104, the network device 1 then determines network security state information of the target WiFi network based on the first network security monitoring information. In an implementation, the user equipment 2 may upload a portion or all of the first network security monitoring information which may be detected and is related to network security to the network device 1. The network device 1 in turn analyzes and determines the security condition of the target WiFi network based on the first network security monitoring information.

In an implementation, when the first network security monitoring information comprises one or more pieces of network security metrics information, security determination on specific network security metrics information may be made based on a certain security standard. In an implementation, the security standard may be set in advance and stored in the network device 1. In an example, for the encryption mode information of the target WiFi network, it may be set so that an encryption mode of OPEN corresponds to failing a corresponding security standard, and an encryption mode of WPA-PSK (TKIP) plus WPA2-PSK (AES) corresponds to passing a corresponding security standard. In another example, for detection information indicating whether the target WiFi is a phishing WiFi, it may be set so that if the target WiFi is not phishing WiFi, a corresponding security standard is passed in an implementation. If the target WiFi is a phishing WiFi or the target WiFi is suspected to be phishing Wifi, a corresponding security standard is failed. Here, the security standard may be loosened or tightened flexibly based on demands. In an example, for detection information indicating whether the target WiFi is a phishing WiFi, if the security standard is loosened, it may be set so that a target WiFi suspected to be a phishing WiFi may correspond to passing a corresponding security standard.

Here, it should be understood by those skilled in the art that the above-mentioned security standards corresponding to network security metrics information are merely examples. Other existing security standards corresponding to network security metrics information or security standards corresponding to network security metrics information that might appear in the future, if applicable to the present application, should also be included in the protection scope of the present application and incorporated herein by reference.

In an embodiment, the network security state information comprises risk information. The risk information is determined based on a situation where at least one piece of network security metrics information of the one or more pieces of network security metrics information is lower than a corresponding security standard. Further, the network security state information may also include security information. The security information is determined based on a situation where all of the network security metrics information is higher than corresponding security standards.

In an implementation, the risk information may include that the target WiFi network has a high probability of having security issues or security risks which is determined by the network device 1 based on the first network security monitoring information. Further, in an implementation, the risk information may also include specific risk levels information, for example, different levels of a potential risk, a general risk, or a high risk. Here, the risk information is determined based on a situation where at least one piece of network security metrics information of the one or more pieces of network security metrics information is lower than a corresponding security standard. In an implementation, if there is at least one piece of network security metrics information failing a corresponding security standard, the network device 1 may determine the network security state information of the target WiFi network based on the at least one piece of network security metrics information. The network security state information includes the risk information of the target WiFi network. In addition, the network security state information may also include a portion or all of the network security metrics information, for example, the network security state information may include the at least one piece of network security metrics information that is lower than a corresponding security standard. A possible example is that the network security state information of the target WiFi network includes that the network has a potential risk. Or another possible example is that the network security state information of the target WiFi network includes network security metrics information indicating that the webpage is suspected to have malicious code, or the webpage will automatically jump a phishing website. All of the network security metrics information is lower than a corresponding security standard. The network security state information may also include risk information of the target WiFi network determined based on the network security metrics information. The risk information is of highly risk. In an implementation, weight information of different network security metrics information may be set. Network security metrics information with heavy weights have more impact on the determination of the network security state information than network security metrics information with light weights.

In an implementation, the security information may include that the target WiFi network does not have security issues or has a low probability of having security risks which is determined by the network device 1 based on the first network security monitoring information. Here, the security information is determined by all of the network security metrics information which is higher than a corresponding security standard. In an implementation, when the all the network security metrics information contained by the first network security monitoring information is higher than a corresponding security standard, it is determined that the network security state information comprises security information, i.e., the network is secure or is of low probability of security risk.

In an embodiment of the present application, at step S104, the network device 1 may determine the network security state information of the target WiFi network based on the first network security monitoring information acquired from the user equipment 2 in connection with second network security monitoring information about the target WiFi network acquired from one or more other user equipments. Here, each piece of the second network security monitoring information may include one or more pieces of network security metrics information.

In practical applications, the network device 1 may store a number of, for example, massive amounts of wireless router information corresponding to WiFi networks and/or access information of WiFi networks. The information may be submitted by an administrative user of the WiFi network. A requesting user may request to acquire related information corresponding to a WiFi network and uses the corresponding WiFi network for Internet access. Here, the WiFi network may include the target WiFi network in the present application as well as a network that may be shared and is similar to the target WiFi network. The requesting user may include a user corresponding to the user equipment 2 in the present application or users who have demands for network connection corresponding to other user equipments.

In the embodiment, to determine the network security state information of the target WiFi network more accurately, the network device 2 may acquire the first network security monitoring information of the target WiFi network from the user equipment 2 and acquire the second network security monitoring information of the same target WiFi network from other user equipments, and determine the network security condition of the target WiFi network based on the acquired detection information which is more comprehensive. In an embodiment, the first network security metrics information of the user equipment 2 and the second network security metrics information of each of the other user equipments may be combined into a set, and the network security state information of the target WiFi network may be determined based on a corresponding security standard. In an implementation, multiple candidate network security metrics information of the target WiFi network may be calculated based on the first network security metrics information of the user equipment 2 and the second network security metrics information of each of the other user equipments respectively according to a same security standard. In an example, candidate network security monitoring information 1 of the target WiFi network is security information, candidate network security monitoring information 2 is risk information, candidate network security monitoring information 3 is risk information. . . . In an implementation, the network security state information of the target WiFi network may be determined based on a proportion of security information or risk information in the multiple pieces of candidate network security state information. In an example, if the proportion of candidate network security state information including risk information is high, the network security state information of the target WiFi network may be determined as including risk information, i.e., the target WiFi network has security issues or has a high probability of having security risks.

In an embodiment, a time interval between the time when the first network security monitoring information is acquired and the time when the second network security monitoring information is acquired is less than a preset time threshold. In an implementation, the first network security monitoring information submitted by the user equipment 2 is matched with a corresponding timestamp. The second network security monitoring information submitted by other user equipments 2 is also matched with a corresponding timestamp. The timestamp may be the time when the network device 1 received the first network security monitoring information or may be the time when the second network security monitoring information is acquired. Here, the timestamp may correspond to the time information when the first network security monitoring information and the second historic network security monitoring information is determined and generated. The timestamp may also correspond to the time information when the first network security monitoring information or the second network security monitoring information is uploaded.

Here, a time interval between the time when the first network security monitoring information is acquired and the time when the second network security monitoring information is acquired may be set as less than a preset time threshold, which ensures time effectiveness and accuracy of the determined network security state information.

In an embodiment, at step S104, when the number of pieces of network security metrics information, which is lower than a corresponding security standard, of the first network security monitoring information reaches a preset threshold, the network security state information of the target WiFi network is determined based on the first network security monitoring information of the user equipment in connection with the second network security monitoring information corresponding to one or more other user equipments. Here, determining the network security state information of the target WiFi network of the user equipment 2 in connection with the second network security monitoring information provided by other user equipments may be based on a trigger condition. In an implementation, the trigger condition may be that the number of pieces of network security metrics information, which is lower than a corresponding security standard, of the first network security monitoring information reaches a preset threshold. In another implementation, the trigger condition may also be based on a request from the user equipment 2. In an example, the user equipment 2 may determine the network security of the target WiFi network as one of different security levels preliminarily, such as secure, insecure, suspected to be insecure, based on the various network security metrics information in connection with a certain determination rule. An example of the determination rule may be that when at least one piece of network security metrics information labeled as important has security risk, the preliminary determination information on network security is determined as insecure. In an example, detection information indicating whether the target WiFi is a phishing WiFi is set as important network security metrics information. If it is detected that the target WiFi is a phishing WiFi, the preliminary determination information on the network security corresponding to the target WiFi network may be determined as insecure. The user equipment 2 in turn may upload the preliminary determination information of being insecure as well as the network security metrics information to the network device 1. The network device 1 may determine the network security information of the target WiFi network based on the received preliminary determination information of being insecure, the first network security monitoring information of the user equipment in connection with the second network security monitoring information corresponding to one or more other user equipments, which further improves the accuracy of network security monitoring.

At step S106, the network device 1 then provides the first network security state information to an administrative user of the target WiFi network. In an implementation, the administrative user of the target WiFi network may include a user who is able to manage or control the wireless router corresponding to the target WiFi network. In an example, the administrative user may be the owner or authorized manager of the wireless router. In an implementation, the wireless router may include a normal wireless router or an intelligent router.

In an embodiment of the present application, the method further comprises step S108 (not shown). At step S108, the network device 1 may acquire wireless router information corresponding to the target WiFi network and/or access information of the target WiFi network submitted by a sharing user and determine the sharing user as an administrative user of the target WiFi network. At step S106, the network device 1 then may provide the network security state information to the administrative user of the target WiFi network. Here, the administrative user of the target WiFi network may be set as a user who is able to submit the wireless router information corresponding to the target WiFi network and/or access information of the target WiFi network, thereby determining that the administrative user is able to manage the wireless router corresponding to the target WiFi network.

In an embodiment of the present application, at step S106, if the network security state information comprises risk information, the network security state information and a security management policy of the corresponding wireless router are provided to the administrative user of the target WiFi network. If the target WiFi network has corresponding risk information, a security management policy of the corresponding wireless router may be provided to the administrative user of the target WiFi network along with the network security state information. In an example, the administrative user may be prompted to modify the encryption mode of the wireless router of the target WiFi network to a more complicated encryption mode. In another example, the administrative user may be prompted to update the firmware of the wireless router. In a further example, the administrative user may be prompted to turn on or update the firewall functions of the wireless router. In yet another example, the administrative user may be prompted to turn on MAC address filtering functions, or to bond MAC addresses of devices authorized to access. In an implementation, a targeted security management policy may be provided to a specific piece of network security metrics information contained in the network security state information. Here, it should be understood by those skilled in the art that the above-mentioned security management policies of the wireless router are merely examples. Other existing security management policies of the wireless router or security management policies of the wireless router that might appear in the future, if applicable to the present application, should also be included in the protection scope of the present application and incorporated herein by reference.

In an embodiment of the present application, the method further comprises step S110 (not shown). At step S110, the network device 1 may provide network security prompt information to devices using the target WiFi network based on the network security state information. In an implementation, the devices using the target WiFi network may include one or more devices currently using the target WiFi network, e.g., the user equipment 2. Correspondingly, at step S107 (not shown), the user equipment 2 may receive the network security prompt information of the target WiFi network that is transmitted by the network device. In an implementation, the network security prompt information may include prompt information indicating whether the target WiFi network is secure or risky. In another implementation, the network security prompt information may also include response suggestion information in case the target WiFi network is risky. In an example, the user of the user equipment 2 is prompted to perform device security scanning or virus detection, or the user equipment 2 is prompted to alter a WiFi network to connect. Here, it should be understood by those skilled in the art that the above-mentioned network security prompt information is merely an example. Other existing network security prompt information or network security prompt information that might appear in the future, if applicable to the present application, should also be included in the protection scope of the present application and incorporated herein by reference.

Here, in the present application, a network device 1 acquires network security monitoring information corresponding to a target WiFi network acquired when a user equipment 2 is connected to the target WiFi network, and provides network security state information of the target WiFi network which is determined based on the first network security monitoring information to an administrative user of the target WiFi network. In the present application, the network security state information of the target WiFi network may be determined based on the first network security monitoring information acquired by devices using the target WiFi network, such as the user equipment 2, via scanning. The network device 1 provides the determined network security state information to the administrative user of the target WiFi network to implement security management of the target WiFi network. Here, the present application is a breakthrough to a conventional operation of network security detection by means of security scanning of an intelligent router in the prior art. Even if the target WiFi is connected via only a normal router, real-time security monitoring of the network may be implemented by the technical solution of the present application. Meanwhile, based on the technical solution of the present application, real time security conditions of Internet users when using WiFi networks may be accurately reflected. Compared with the security scanning by an intelligent router, the technical solution of the present application may better meet the timeliness requirements of network security protection, and make up for possible loopholes in the security detection of the intelligent router.

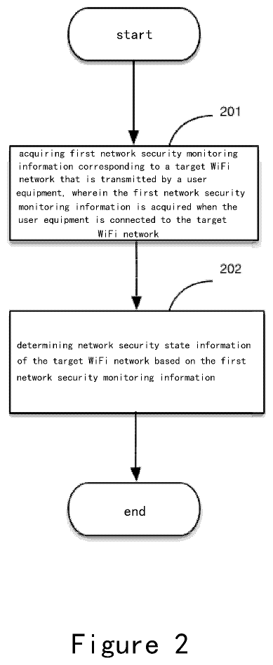

The present application also provides a method for security monitoring of a WiFi network at a network device. FIG. 2 shows a flowchart of a method for security monitoring of a WiFi network at a network device according to another aspect of the present application. The method comprises step S201 and step S202.

Specifically, at step S201, a network device 3 acquires first network security monitoring information corresponding to a target WiFi network that is transmitted by a user equipment 4, wherein the first network security monitoring information is acquired when the user equipment 4 is connected to the target WiFi network. At step S202, the network device 3 then determines network security state information of the target WiFi network based on the first network security monitoring information. Here, step S201 and step S202 are identical or similar to step S102 and step S104 in FIG. 1, and therefore are not repeated here and are incorporated herein by reference.

Here, in the present application, a network device 3 acquires first network security monitoring information corresponding to a target WiFi network acquired when a user equipment 4 is connected to the target WiFi network, and determines network security state information of the target WiFi network based on the first network security monitoring information. In the present application, the network security state information of the target WiFi network may be determined based on the first network security monitoring information acquired by devices using the target WiFi network, such as the user equipment 4, via scanning. The network device 3 determines the network security state information of the target WiFi network based on analysis of the first network security monitoring information. Here, the present application is a breakthrough to a conventional operation of network security detection by means of security scanning of an intelligent router in the prior art. Even if the target WiFi is connected via only a normal router, real-time security monitoring of the network may be implemented by the technical solution of the present application. Meanwhile, based on the technical solution of the present application, real time security conditions of Internet users when using WiFi networks may be accurately reflected. Compared with the security scanning by an intelligent router, the technical solution of the present application may better meet the timeliness requirements of network security protection, and make up for possible loopholes in the security detection of the intelligent router. In addition, the network device 3 may perform further network security analysis on the monitoring result from the user equipment 4 based on actual needs to improve the accuracy of network security monitoring.

The embodiments of the present application also provide a device for security monitoring of a WiFi network. The device comprises:

one or more processors;

a memory; and

one or more programs stored in the memory and configured to be executed by the one or more processors, wherein the programs, when executed by the one or more processors, cause the one or more processors to implement the method as recited in any one of abovementioned clauses.

Here, the device may include the network device or the user equipment in the present application.

The embodiments of the present application also provides a computer readable storage medium storing computer programs thereon, wherein the computer programs when executed, cause the method as recited in any one of the abovementioned clauses to be performed.

Obviously, those skilled in the art may make various modifications and variations to the present application without departing from the spirit and scope of the present application. In this way, if these modifications and variations to the present application fall within the scope of the claims of the present application and their equivalent technologies, the present application is also intended to encompass these modifications and variations.

It should be noted that the present disclosure may be implemented in software and/or a combination of software and hardware, for example, by using an application specific integrated circuit (ASIC), a general purpose computer, or any other similar hardware device. In one embodiment, the software program of the present disclosure may be executed by a processor to implement the steps or functions described above. Likewise, the software programs (including related data structures) of the present disclosure may be stored in a computer readable storage medium such as a RAM memory, a magnetic or optical drive or a floppy disk and the like. In addition, some of the steps or functions of the present disclosure may be implemented in hardware, for example, as a circuit that cooperates with a processor to perform various steps or functions.

In addition, a portion of the present disclosure may be embodied as a computer program product, such as computer program instructions, when executed by a computer, may invoke or provide a method and/or technical solution in accordance with the present disclosure. The program instructions for invoking the method of the present disclosure may be stored in a fixed or removable storage medium, and/or transmitted by a data stream in a broadcast or other signal carrier medium, and/or stored in a working memory of the computer device in which the program instructions run. Herein, an embodiment in accordance with the present disclosure includes an apparatus including a memory for storing computer program instructions and a processor for executing program instructions, wherein when the computer program instructions are executed by the processor, triggering the apparatus to operate the aforementioned methods and/or technical solutions in accordance with various embodiments of the present disclosure.

For those skilled in the art, it is apparent that the present application is not limited to the details of the above-mentioned exemplary embodiments, and the present application may be implemented in other specific forms without departing the spirit or basic features of the present application. Therefore, the present embodiments are to be considered as illustrative and not restrictive. The scope of the present application is defined by the appended claims rather than the above-mentioned description, and therefore it is intended that all changes which fall within the meaning and range of equivalency of the claims are embraced in the present application. Any reference signs in the claims should not be construed as limiting the claims involved. In addition, it is apparent that the word “comprising” does not exclude other elements or steps, and the singular does not exclude the plural. A plurality of units or means stated in the apparatus claims may also be implemented by one unit or means by means of software or hardware. The terms first and second and the like are used to represent names and do not represent any particular order.

What is claimed is:

1. A method for security monitoring of a WiFi network at a network device, the method comprising:
acquiring first network security monitoring information corresponding to a target WiFi network that is transmitted by a user equipment, wherein the first network security monitoring information is acquired when the user equipment is connected to the target WiFi network;
determining network security state information of the target WiFi network based on the first network security monitoring information; and
providing the network security state information to an administrative user of the target WiFi network.

2. The method according to claim 1, wherein the first network security monitoring information comprises one or more pieces of network security metrics information.

3. The method according to claim 2, wherein the network security state information comprises risk information, and the risk information is determined by at least one network security metrics information, which is lower than a corresponding security standard, of the one or more pieces of network security metrics information.

4. The method according to claim 3, wherein the step of providing the network security state information to the administrative user of the target WiFi network comprising:
if the network security state information comprises risk information, providing the network security state information and a security management policy of a matching wireless router to the administrative user of the target WiFi network.

5. The method according to claim 1, wherein the step of determining the network security state information of the target WiFi network based on the first network security monitoring information comprising:
determining the network security state information of the target WiFi network based on the first network security monitoring information in connection with second network security monitoring information on the target WiFi network acquired by one or more other user equipments.

6. The method according to claim 5, wherein a time interval between a first time interval when the first network security monitoring information is acquired and a second time interval when the second network security monitoring information is acquired is less than a preset time threshold.

7. The method according to claim 5, wherein the step of determining the network security state information of the target WiFi network based on the first network security monitoring information comprising:
when a number of pieces of network security metrics information, which is lower than a corresponding security standard, of the first network security monitoring information reaches a preset threshold, determining the network security state information of the target WiFi network based on the first network security monitoring information in connection with the second network security monitoring information on the target WiFi network acquired by one or more other user equipments.

8. The method according to claim 1, wherein the method further comprising:
acquiring wireless router information corresponding to the target WiFi network and/or access information of the target WiFi network submitted by a sharing user;
determining the sharing user as the administrative user of the target WiFi network;
wherein providing the network security state information to the administrative user of the target WiFi network comprising:
providing the network security state information to the administrative user.

9. The method according to claim 1, wherein the method further comprising:
based on the network security state information, providing network security prompt information to devices using the target WiFi network.

10. A method for security monitoring of a WiFi network at a user equipment, the method comprising:
connecting to a target WiFi network;
scanning first network security monitoring information of the target WiFi network when the user equipment is connected to the target WiFi network; and
transmitting the first network security monitoring information to a corresponding network device.

11. The method according to claim 10, wherein the method further comprising:
receiving network security prompt information on the target WiFi network transmitted by a network device.

12. A device for security monitoring of a WiFi network, comprising:
one or more processors;
a memory; and
one or more programs stored in the memory and configured to be executed by the one or more processors, the programs comprising instructions to:
acquire first network security monitoring information corresponding to a target WiFi network that is transmitted by a user equipment, wherein the first network security monitoring information is acquired when the user equipment is connected to the target WiFi network;
determine network security state information of the target WiFi network based on the first network security monitoring information; and
provide the network security state information to an administrative user of the target WiFi network.
